(19) United States
(12) Patent Application Publication
(10) Pub. No.: US 2018/0367329 A1
(43) Pub. Date: Dec. 20, 2018

(54) INTERNET-OF-THINGS SYSTEM FOR RECOGNIZING USER BEHAVIOR AND CONTROLLING THINGS

(71) Applicant: GREENCOMM CO., LTD., Anyang-si (KR)

(72) Inventor: Ki Chul SHIN, Gunpo-si (KR)

(21) Appl. No.: 16/060,639

(22) PCT Filed: Dec. 8, 2016
(86) PCT No.: PCT/KR2016/014342

§ 371 Date: Jun. 8, 2018

(30) Foreign Application Priority Data
Dec. 8, 2015 (KR) 10-2015-0174086

(51) Int. Cl. H04L 12/28; G06F 1/16

(52) U.S. Cl. CPC H04L 12/282; H04L 2012/285; G06F 1/163

(57) ABSTRACT

Provided is an IoT system comprising: a plurality of IoT devices; a wearable device worn by a user on a predetermined area of a body, wherein the wearable device is configured to transmit a behavior data in response to a user's operation signal; and a server configured to transmit a control data controlling at least one IoT device in the plurality of IoT devices in response to the behavior data.

### FIELD OF THE DISCLOSURE

The teachings in accordance with exemplary and non-limiting embodiments of this invention relate generally to an Internet-of-things system configured to control things by recognizing a user behavior.

### DESCRIPTION OF RELATED ART

In general, the Internet is the global system of interconnected computer networks that use the Internet protocol suite (e.g., TCP, Transmission Control Protocol/IP, Internet Protocol) to link devices worldwide. The IoT (Internet of Things) is based on an idea in which virtually any type of physical thing can be decipherable, recognizable, position-determinable, addressable and controllable without requiring human-to-human or human-to-computer interaction through an IoT communication network (e.g., Ad hoc system or internet). That is, the IoT is a new information communication base capable of allowing human-to-things and things-to-things to mutually communicate at all times by connecting existing physical things.

The IoT device was conventionally controlled through applications of mobile terminals or personal computers such as smart phones or smart pads. For example, a user has controlled a variety of IoT devices by controlling a boiler temperature, closing a gas valve, setting a completion time of washer or turning on a power of an electric rice cooker through activation of applications of mobile terminals from outside. However, this type of input method must involve a step of activating an application of a mobile terminal by a user, and when the user cannot recognize activation of mobile terminal, there may arise a problem of difficulty in controlling the IoT devices.

### Technical Problem

It is a technical subject of the present invention to provide an IoT system configured to control an IoT device by automatically recognizing a user behavior and to control the IoT device through big data analysis relative to the user behavior.

### Technical Solution

In one aspect of the present disclosure, there may be provided an IoT system, the system comprising: a plurality of IoT devices; a wearable device worn by a user on a predetermined area of a body, wherein the wearable device is configured to transmit a behavior data in response to a user's operation signal; and a server configured to transmit a control data controlling at least one IoT device in the plurality of IoT devices in response to the behavior data.

In some exemplary embodiment of the present invention, the wearable device may include: a sensor part configured to detect the operation signal, an analysis part configured to determine the behavior data in response to the operation signal, and a storage configured to store the behavior data in response to the operation signal.

In some exemplary embodiment of the present invention, the server may be further configured to pre-store the control data in response to the behavior data.

In another general aspect of the present invention, there may be provided an IoT system, the system comprising: a plurality of IoT devices; a wearable device worn by a user on a predetermined area of a body, wherein the wearable device is configured to detect and transmit a user's operation signal; and a server configured to transmit a control data controlling at least one IoT device in the plurality of IoT devices in response to the operation signal.

In some exemplary embodiment of the present invention, the server includes: an analysis part configured to analyze a user behavior pattern in response to the operation signal, and a storage configured to store the control data in response to the behavior pattern.

In some exemplary embodiment of the present invention, the storage may be further configured to store the behavior pattern in response to the operation signal.

In some exemplary embodiment of the present invention, the analysis part may determine the behavior pattern in response to the operation signal by analyzing the behavior pattern stored in the storage.

In another general aspect of the present invention, there may be provided an IoT system, the system comprising: a plurality of IoT devices; a wearable device worn by a user on a predetermined area of a body, the wearable device is configured to detect and transmit a user's operation signal; a mobile terminal configured to transmit a behavior data in response to the operation signal; and a server configured to transmit a control data controlling at least one IoT device in the plurality of IoT devices in response to the behavior data.

In some exemplary embodiment of the present invention, the mobile terminal may include: an analysis part configured to determine the behavior data in response to the operation signal, and a storage configured to store the behavior data in response to the operation signal.

In some exemplary embodiment of the present invention, the server may be further configured to pre-store the control data in response to the behavior data.

### Advantageous Effects

The abovementioned present invention has an advantageous effect in that a user convenience can be enhanced because a control data of IoT device in response to a user operation signal can be automatically transmitted without recourse to the need of inputting, by a user, the control data of the IoT device to a terminal.

### BRIEF DESCRIPTION OF DRAWINGS

FIG. 1 is a schematic view illustrating an IoT system according to an exemplary embodiment of the present invention.

FIG. 2 is a schematic block diagram illustrating a wearable device according to an exemplary embodiment of the present invention.

FIG. 3 is a schematic diagram illustrating a wearable device according to another exemplary embodiment of the present invention.

FIG. 4 is a schematic exemplary diagram illustrating a configuration of an IoT server in response to the wearable device of FIG. 3.

### BEST MODE

The invention described hereunder may be applied with various changes and several exemplary embodiments, and particular exemplary embodiments will be described in detail through exemplary drawings and detailed descriptions.

However, it should be noted that the present invention is not limited to particular exemplary embodiments, and it will be appreciated that the present invention described is intended to embrace all such alterations, modifications, and variations that fall within the scope and novel idea of the present invention. Hereinafter, exemplary embodiments of the present invention will be described in detail with reference to the accompanying drawings.

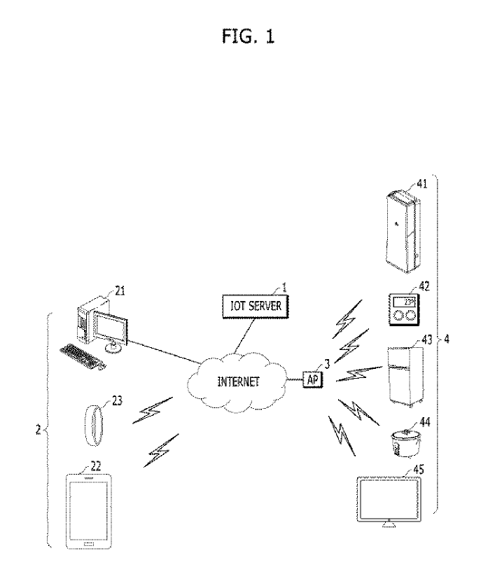

FIG. 1 is a schematic view illustrating an IoT system according to an exemplary embodiment of the present invention.

As illustrated in the drawing, the IoT system according to an exemplary embodiment of the present invention may include an IoT server (1), a user terminal (2), an AP (Access Point, 3) and an IoT device (4).

The IoT device (4) may be configured to communicate through the AP (3) and an air interface, where the air interface may comply with a wireless Internet protocol such as IEEE802.11. Although the exemplary embodiment of the present invention has exemplarily explained that the IoT device (4) communicates with the AP (3) through the air interface, each IoT device (4) may communicate through one of a wired manner and a wireless manner, or through both the wired manner and the wireless manner.

The IoT device (4) may include an air conditioner (41), a temperature controller (42) of a boiler, a refrigerator (43), an electric rice cooker (44) and a TV (45). However, these electric appliances are simply exemplary, and the IoT device (4) may include other various things in the house in addition thereto.

Albeit not being illustrated, Internet may include a plurality of routing agents and processing agents. The Internet is the global system of interconnected computer networks that use the Internet protocol suite (e.g., TCP, Transmission Control Protocol/IP, Internet Protocol) to link devices worldwide. The TCP/IP may provide end-to-end communication (connectivity) specifying how data should be packetized, addressed, transmitted, routed and received.

The user terminal (2) may include a wired terminal (21) in user house, a mobile terminal (22) and a wearable device (23) worn by a user at a predetermined area of the user. Although a desktop type personal computer (PC) is illustrated here as an example of wired terminal (21), the present invention is not limited thereto. Although the wired terminal (21) is included in the user terminal (2), the wired terminal may be also included in the IoT device (4).

The mobile terminal (22) is a terminal carried by a user and may be realized in a type of a smart phone or a smart pad, for example. Furthermore, the wearable device (23) is a device worn by a user at a predetermined area of a body, and may be worn on a wrist in a type of a watch, for example.

The wearable device (23) in the present invention may include a predetermined sensor and a communication part to automatically recognize a user behavior, where the user behavior may be transmitted to the IoT server (1) through the Internet, or may be also transmitted to the mobile terminal (22). The detailed configuration of wearable device (23) will be described later with reference to the accompanying drawings.

That is, although FIG. 1 has illustrated that the wearable device (23) communicates with the IoT server (1) through the Internet, the present invention is not limited thereto, and the wearable device (23) may also communicate with the mobile terminal (22).

The AP(3) may be connected to the Internet through optical communication system modem, cable modem and DSL (Digital Subscriber Line) modem. The AP(3) may also communicate with the IoT device (4) and the Internet using standard Internet protocol (e.g., TCP/IP). The IoT server (1) may be embodied with a plurality of structurally separate servers, or may be formed with a single server.

Hereinafter, the operation of conventional IoT system will be first explained and then the operation of the system according to the present invention will be described.

Conventionally, in case a user wants to control a temperature controller (42) of a boiler from outside, and when an application of a mobile terminal (22) is driven to adjust the temperature through a relevant application, a relevant data is transmitted to the IoT server (1) through the mobile terminal (22). When the IoT server (1) transmit a control data corresponding thereto to the AP (3) through the Internet, the temperature controller (42) having received the control data from the AP (3) operates in a style of being controlled by the control data. Alternatively, the control may be made by the wired terminal (21) instead of the mobile terminal (22).

That is, when a user inputs a data to the wired terminal (21) or to the mobile terminal (23) in order to control the IoT device (4), the IoT server (1) transmits the control data corresponding to the relevant data to the AP (3) through the Internet, and the IoT device (4) having received the control data from the AP (3) is controlled by the relevant control data. As discussed in the foregoing, the conventional IoT system was such that a user could control the IoT device (4) using the wired terminal (21) or the mobile terminal (23).

However, in the present invention, the IoT device (40) can be controlled by a user behavior without recourse to intervention of the wired terminal (21) or the mobile terminal (22).

That is, when a behavior pattern of a user wearing the wearable device (23) is recognized and a predetermined behavior data corresponding to the behavior pattern is transmitted to the IoT server (1), a control data corresponding to the relevant behavior is transmitted by the IoT server (1) to the AP (3), where the IoT device (4) having received the relevant control data from the AP (3) may be controlled by the relevant control data. At this time, the behavior data recognized by the wearable device (23) may be also transmitted to the IoT server (1) directly through the Internet, and may be also transmitted to the IoT server (1) through the mobile terminal (22).

For example, when a user wakes up in the morning, the wearable device (23) may transmit a data related to the user behavior to the IoT server (1), where the IoT server (1) recognizes that the user has woken up to turn on the power of an electric rice cooker (44), or operate an air conditioner (41).

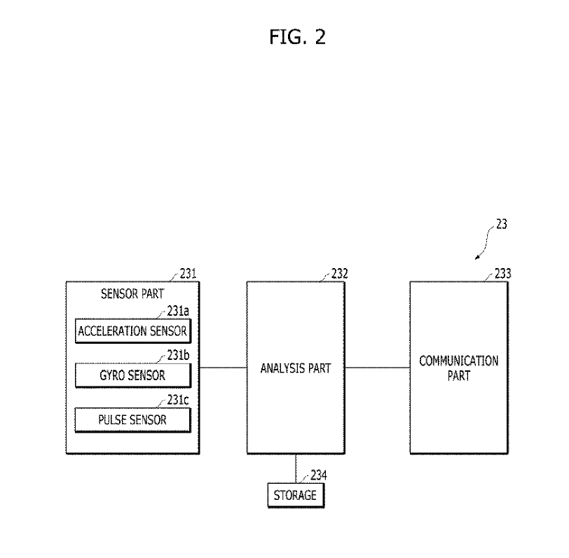

FIG. 2 is a schematic block diagram illustrating a wearable device according to an exemplary embodiment of the present invention.

As illustrated in the drawing, the wearable device (23) according to an exemplary embodiment of the present invention may include a sensor part (231), an analysis part (232) and a communication part (233).

The sensor part (231) may measure an acceleration speed of an operating arm (in case of being worn on a wrist) of a user, an angular speed and a user's heart rate. For example, the sensor part (231) may include an acceleration speed sensor (231a) measuring an acceleration speed of an arm, a gyro sensor (231b) measuring position and direction of arm by detecting a rotation inertia of an arm and a pulse sensor (231c) measuring the heart rate of the user.

The acceleration speed sensor (231a) may provide information such as increase/decrease ratio of speed relative to linear motion or intensity of applied shock, and the gyro sensor (231b) may provide information such as rotational motion and direction of body by detecting the acceleration speed rotated by an object for unit time.

The acceleration speed sensor (231a) and the gyro sensor (231b) may be provided in a shape of 6-axis sensor (3-axis acceleration sensor and 3-axis gyro sensor) measuring an acceleration speed of x, y, z axes in order to distinguish various performed operations. The rotation of user body (arm), direction, acceleration speed data and the pulse rate measured by the sensor part (231) may be transmitted to the analysis part (232).

Hereinafter, the data of operation measured by the sensor part (231) currently performed by a user may be called an “operation signal” in this specification. That is, the operation signal in the present invention may include an acceleration speed of a body of a user, an angular speed and heart rate of the user.

The analysis part (232) may determine the user behavior from the operation signal measured by the sensor part (231). For example, the analysis part (232) may determine that the user has woken up when the user is recognized of motion under a sleep state. The behavior pattern corresponding to the operation signal of the user may be stored in the storage (234).

The communication part (233) may transmit to the IoT server (1) through the Internet the user behavior data determined by the analysis part (232). The IoT server (1) having received the user behavior data may transmit to the AP (3) through the Internet a control data for controlling more than one in the IoT device (4) in response to a relevant behavior data, and any one in the IoT device (4) having received the control data through the AP (3) may be controlled by the relevant control data.

That is, for example, when the analysis part (232) determines by the operation signal recognized by the sensor part (231) that the user has woken up, the IoT server (1) may transmit a control data for controlling the rice cooker (44) and the air conditioner (41) to the AP(3), and the rice cooker (44) and the air conditioner (41) may be turned on respectively by the relevant control data.

Alternatively, for example, the analysis part (232) may also determine by the operation signal recognized by the sensor part (231) that the user has left from the office. That is, when a user moves to use a public transportation in order to go home after finishing the office work on a chair, the analysis part (232) may recognize that the user has left for home according to the operation signal. In this case, the IoT server (1) having received from the analysis part(232) that the user behavior infers ‘left work’ may transmit to the AP (3) a control data for increasing a temperature in the house, and the temperature controller (42) may control (adjust) an indoor temperature in response to the relevant control data.

Alternatively, for example, the analysis part (232) may determine that the user is in a dangerous situation after leaving the office for home according to the operation signal recognized by the sensor part (231). That is, in case a user suddenly runs while moving at a normal peaceful speed, the analysis part (232) may recognize that the user has run into a danger according to the relevant operation signal. In this case, the IoT server (1) having received from the analysis part (232) through the wired terminal (21) {in this case, the wired terminal (21) may correspond to the IoT device (4)} that the user has run into a ‘danger’ may transmit the control data to the AP (3) in order to contact a nearby police station, and the wired terminal (21) may transmit a message to the nearby police station based on the relevant control data.

However, the above explanation is merely exemplary, and the present invention is not limited thereto, and the behavior may be recognized from the user operation signal in various methods to thereby control the IoT device (4).

Although the foregoing explanation has described that the wearable device (23) had recognized the user behavior, the wearable device (23) may transmit the operation signal of user to the IoT server (1), where the IoT server (1) that has received the operation signal may also recognize the user behavior.

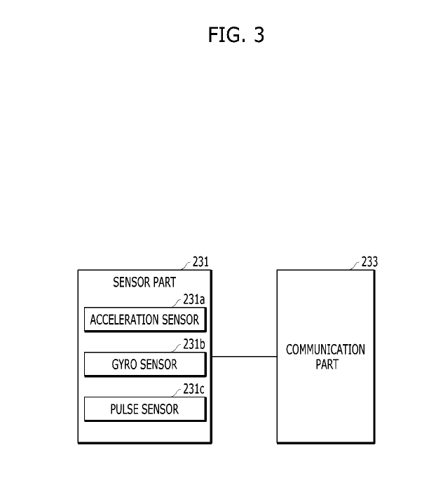

FIG. 3 is a schematic diagram illustrating a wearable device according to another exemplary embodiment of the present invention.

As shown in the drawing, the wearable device (23) according to another exemplary embodiment of the present invention may include a sensor part (231) and a communication part (233).

The sensor part (231) may measure an acceleration speed of an operating arm (in case of being worn on a wrist) of a user, an angular speed and a user's heart rate. For example, the sensor part (231) may include an acceleration speed sensor (231a) measuring an acceleration speed of an arm, a gyro sensor (231b) measuring position and direction of arm by detecting a rotation inertia of an arm and a pulse sensor (231c) measuring the heart rate of the user.

The acceleration speed sensor (231a) may provide information such as increase/decrease ratio of speed relative to linear motion or intensity of applied shock, and the gyro sensor (231b) may provide information such as rotational motion and direction of body by detecting the acceleration speed rotated by an object for unit time.

The acceleration speed sensor (231a) and the gyro sensor (231b) may be provided in a shape of 6-axis sensor (3-axis acceleration sensor and 3-axis gyro sensor) measuring an acceleration speed of x, y, z axes in order to distinguish various performed operations.

The operation signal including the rotation of user body (arm), direction, acceleration speed data and the pulse rate measured by the sensor part (231) may be transmitted to the IoT server (1) through the Internet.

The IoT server (1) having received the operation signal may determine the user behavior from the user operation signal and may transmit to the AP (3) through the Internet a control data for controlling more than one in the IoT device (4) in response to a relevant user behavior, and any one in the IoT device (4) having received the control data through the AP (3) may be controlled by the relevant control data.

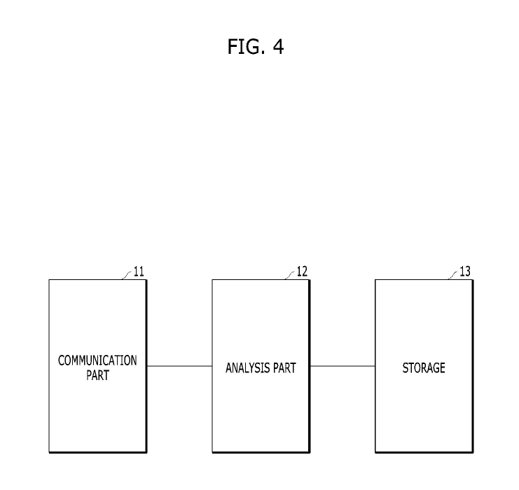

FIG. 4 is a schematic exemplary diagram illustrating a configuration of an IoT server in response to the wearable device of FIG. 3.

As shown in the drawing, the IoT server (1) according to an exemplary embodiment of the present invention may include analysis part (12) determining a behavior from the user operation signal, storage (13) storing a behavior pattern in response to the operation signal and a control data relative to the IoT device (4) corresponding to the behavior pattern, and a communication part (11) transmitting and receiving data through the Internet.

Now, the above-explained example is introduced again. When an operation signal recognized by the sensor part (231) is received through the communication part (11), the analysis part (12) may determine by the relevant operation signal that the user has woken up, the analysis part (12) may transmit a control data for controlling the rice cooker (44) and the air conditioner (41) to the AP(3), and the rice cooker (44) and the air conditioner (41) may be turned on respectively by the relevant control data.

Alternatively, for example, when the operation signal recognized by the sensor part (231) is received, the analysis part (12) may determine that the user has left for home from the office. That is, when a user moves to use a public transportation in order to go home after finishing the office work while sitting a chair, the analysis part (12) may recognize that the user has left for home according to the operation signal, and may transmit a control data for increasing a home temperature in response to the relevant behavior pattern, and the temperature controller (42) may adjust an indoor temperature in response to the relevant control data.

Alternatively, for example, when an operation signal recognized by the sensor part (231) is received, the analysis part (12) may determine that the user is in a dangerous situation after leaving the office for home. That is, in case a user suddenly runs while moving at a normal peaceful speed, the analysis part (12) may recognize that the user has run into a danger according to the relevant operation signal, and may transmit to the AP (3) a control data for controlling the wired terminal (21) in response to the relevant behavior pattern. The wired terminal (21) having received the relevant control data through the AP (3) may transmit a message to the nearby police station according to the relevant control data.

Meantime, the analysis part (12) may database the behavior data in response to the operation signal received from the sensor part (231) and a user's next behavior corresponding thereto, which are then stored in the storage (13). The analysis part (12) may implement a series of processes in response to the behavior data corresponding to the user operation signal by analyzing a large amount of data (big data) thus stored.

For example, a user mental state may be determined from a behavior data corresponding to the user operation signal, and a message notifying the user mental state to a mobile terminal of a predetermined opposite party may be transmitted. That is, for example, when a user is determined to be depressed from the behavior data corresponding to the user operation signal, a message notifying that “the user's mental state is in a depressed state”, may be transmitted to a mobile terminal of a predetermined opposite party.

Alternatively, a user's next behavior may be predicted from the behavior data corresponding to the user operation signal, and a control data corresponding thereto may be transmitted to any one of the predetermined IoT devices (4). For example, when it is determined by the analysis part (12) from the user behavior data that a user will take a shower (which can be realized by storing as a data that a user always wakes up at a predetermined time to take a shower when the predetermined time comes up), the analysis part (12) may adjust a temperature by controlling the temperature controller (42).

Meantime, although the abovementioned exemplary embodiment has explained as an example that the wearable device (23) has transmitted the behavior pattern to the IoT server (1) by directly determining the behavior pattern, or the IoT server (1) has determined the behavior pattern from the operation signal of the wearable device (23), the user mobile terminal (22) may receive the operation signal of the wearable device (23) to determine the user behavior pattern, and the received user behavior pattern may be also transmitted to the IoT server (1).

In this case, the communication part (233) of FIG. 3 may transmit the operation signal to the mobile terminal (22) by using a predetermined communication method, instead of transmission of operation signal to the IoT server (1) through the Internet, and the mobile terminal (22) may also transmit a behavior pattern to the IoT server (1) by determining the behavior pattern from a relevant operation signal.

A control data for controlling the IoT device (4) corresponding to the user behavior pattern may be provided in advance by a user to the IoT server (1) through the wired terminal (21) or the mobile terminal (22). For example, a control data to turn on the TV (45) or the air conditioner (41) may be stored in response to a user's waking-up behavior pattern, a control data controlling a temperature of the temperature controller (42) in response to a user's going-to-work behavior pattern or a user's leaving-work behavior pattern may be stored, a control data to turn on a coffee machine may be stored in response to a user's waking-up behavior pattern, albeit not being illustrated in the drawing, or a control data to turn on a robot vacuum cleaner in response to a user's leaving-work behavior pattern may be stored.

Although the present specification has mixedly explained the ‘behavior pattern’ here and there, it should be apparent that the ‘behavior pattern’ demonstrates a user behavior determined by an operation signal, and the ‘behavior data’ means a data communicated between each element, and therefore, the behavior data includes the behavior pattern.

As discussed above, the IoT system according to the present invention is such that when a user operation signal is detected from the sensor part (231) of the wearable device (23), a behavior pattern corresponding to the user operation signal is determined, and the IoT device can be controlled by a control data in response to a relevant behavior pattern.

That is, according to the present invention, there is no need that a user inputs a control data of the IoT device through a wired terminal (21) or a mobile terminal (22), and a control data of the IoT device corresponding to a user operation signal can be transmitted to thereby enhance a user convenience.

Although the abovementioned exemplary embodiments according to the present invention have been described in detail with reference to the above specific examples, the embodiments are, however, intended to be illustrative only, and thereby do not limit the scope of protection of the present invention. Thereby, it should be appreciated by the skilled in the art that various modifications and exemplary embodiments of equivalent scopes to the above examples may be made without deviating from the scope of protection of the invention. Thus, the true technical scope of protection of the invention must be determined by the following claims.

What is claimed is:

1. An IoT system, the system comprising:
a plurality of IoT devices;
a wearable device worn by a user on a predetermined area of a body, wherein the wearable device is configured to transmit a behavior data in response to a user's operation signal; and
a server configured to transmit a control data controlling at least one IoT device in the plurality of IoT devices in response to the behavior data.

2. The IoT system of claim 1, wherein the wearable device includes:
a sensor part configured to detect the operation signal,
an analysis part configured to determine the behavior data in response to the operation signal, and
a storage configured to store the behavior data in response to the operation signal.

3. The IoT system of claim 1, wherein the server is further configured to pre-store the control data in response to the behavior data.

4. An IoT system, the system comprising:
a plurality of IoT devices;
a wearable device worn by a user on a predetermined area of a body, wherein the wearable device is configured to detect and transmit a user's operation signal; and
a server configured to transmit a control data controlling at least one IoT device in the plurality of IoT devices in response to the operation signal.

5. The IoT system of claim 4, wherein the server includes:
an analysis part configured to analyze a user behavior pattern in response to the operation signal, and
a storage configured to store the control data in response to the behavior pattern.

6. The IoT system of claim 5, wherein the storage is further configured to store the behavior pattern in response to the operation signal.

7. The IoT system of claim 6, wherein the analysis part determines the behavior pattern in response to the operation signal by analyzing the behavior pattern stored in the storage.

8. An IoT system, the system comprising:
a plurality of IoT devices;
a wearable device worn by a user on a predetermined area of a body, the wearable device is configured to detect and transmit a user's operation signal;
a mobile terminal configured to transmit a behavior data in response to the operation signal; and
a server configured to transmit a control data controlling at least one IoT device in the plurality of IoT devices in response to the behavior data.

9. The IoT system of claim 8, wherein the mobile terminal includes:
an analysis part configured to determine the behavior data in response to the operation signal, and
a storage configured to store the behavior data in response to the operation signal.

10. The IoT system of claim 7, wherein the server is further configured to pre-store the control data in response to the behavior data.
